(19) United States
(12) Patent Application Publication
(10) Pub. No.: US 2026/0159104 A1
(43) Pub. Date: Jun. 11, 2026

(54) AUTONOMOUS DRIVING KIT

(71) Applicant: TOYOTA JIDOSHA KABUSHIKI KAISHA, Toyota-shi (JP)

(72) Inventor: Atsushi IWAI, Tajimi-shi (JP)

(73) Assignee: TOYOTA JIDOSHA KABUSHIKI KAISHA, Toyota-shi (JP)

(21) Appl. No.: 19/339,717

(22) Filed: Sep. 25, 2025

(30) Foreign Application Priority Data
Dec. 9, 2024 (JP) 2024-214169

(51) Int. Cl. B60W 50/029; B60W 50/02; B60W 60/00

(52) U.S. Cl. CPC B60W 50/029; B60W 50/0205; B60W 60/0015; B60W 2050/0292; B60W 2520/105

(57) ABSTRACT

ADK is attachable to and detachable from VP configured to issue an instruction for autonomous driving and enable autonomous driving. VP includes a base vehicle, a propulsion function unit (propulsion system, braking system) that propels the base vehicle according to a propulsion instruction from ADK, and VCIB that relays control communication between ADK and the propulsion function unit. ADK receives the abnormality information indicating the abnormality of the propulsion function by the propulsion function unit from VCIB, and when the abnormality information is received, transmits an instruction for the travel in the limp home mode to VCIB on condition that the abnormality indicated by the abnormality information is an abnormality requiring a stop. Accordingly, ADK can transmit an instruction for the travel in the limp home mode to VCIB on the condition that the abnormality of the propulsion function of the base vehicle is an abnormality requiring a stop.

### CROSS-REFERENCE TO RELATED APPLICATION

This application claims priority to Japanese Patent Application No. 2024-214169 filed on Dec. 9, 2024. The disclosure of the above-identified application, including the specification, drawings, and claims, is incorporated by reference herein in its entirety.

### BACKGROUND

### 1. Technical Field

The present disclosure relates to an autonomous driving kit, and more particularly, to an autonomous driving kit that issues an instruction for autonomous driving.

### 2. Description of Related Art

Japanese Unexamined Patent Application Publication No. 2024-053730 (JP 2024-053730 A), for example, describes a vehicle platform that can be equipped with an autonomous driving kit. The vehicle platform is hereinafter referred to as a “VP (Vehicle Platform)”. The autonomous driving kit is hereinafter referred to as an “ADK (Autonomous Driving Kit)”. The VP includes a base vehicle and a vehicle control interface box that interfaces between the base vehicle and the autonomous driving system through a communication bus. The vehicle control interface box is hereinafter referred to as a “VCIB (Vehicle Control Interface Box)”. In this VP, fault diagnosis is performed in various systems such as a brake system and a steering system, and fault information is transmitted to the VCIB. Then, information about the presence or absence of a failure indicated by the fault information is transmitted from the VCIB to the ADK.

### SUMMARY

In JP 2024-053730 A, a signal informing the ADK from the VCIB that the function related to the propulsion function is deteriorated is used. See 3.5.2.4 Performance deterioration of Propulsion system in paragraph [0172], for example. However, since the ADK is not able to know the details of the remaining capacity, it is difficult to travel in a limp home mode according to the remaining capacity.

The present disclosure provides an autonomous driving kit capable of appropriately executing travel in a limp home mode according to the remaining capability of a propulsion function.

An aspect of the present disclosure provides an autonomous driving kit that issues an instruction for autonomous driving and that is attachable to and detachable from a vehicle configured to be autonomously drivable. The vehicle includes a vehicle platform, a propulsion function unit that propels the vehicle platform according to a propulsion instruction from the autonomous driving kit, and a vehicle control interface box that relays control communication between the autonomous driving kit and the propulsion function unit. The autonomous driving kit is configured to receive abnormality information indicating an abnormality of a propulsion function of the propulsion function unit from the vehicle control interface box, and when the abnormality information is received, transmit an instruction to travel in a limp home mode to the vehicle control interface box on condition that the abnormality indicated by the abnormality information is an abnormality that requires the vehicle to stop.

According to such a configuration, the autonomous driving kit can transmit an instruction to travel in the limp home mode to the vehicle control interface box on condition that the abnormality of the propulsion function of the vehicle platform is an abnormality that requires the vehicle to stop. As a result, it is possible to provide an autonomous driving kit capable of appropriately executing travel in the limp home mode according to the remaining capacity of the propulsion function.

The autonomous driving kit may be configured to
when the abnormality information is received, transmit required acceleration that matches a situation around the vehicle platform to the propulsion function unit by way of the vehicle control interface box,
receive a response content of a response of the propulsion function unit that matches the required acceleration by way of the vehicle control interface box, and
on further condition that the response content is received, transmit an instruction to travel in the limp home mode that matches whether the response content is appropriate to the vehicle control interface box.

According to such a configuration, when the abnormality information is received from the vehicle control interface box, the autonomous driving kit transmits required acceleration that matches a situation around the vehicle platform to the propulsion function unit. The autonomous driving kit can receive a response content of a response of the propulsion function unit that matches the required acceleration, and transmit an instruction to travel in the limp home mode that matches whether the response content is appropriate to the vehicle control interface box. As a result, it is possible to execute travel in the limp home mode further appropriately according to the remaining capacity of the propulsion function.

The required acceleration may be acceleration that increases or maintains a forward speed of the vehicle platform; and
the response content may be a content indicating whether the propulsion function unit is generating a propulsive force that allows the vehicle platform to travel with acceleration or travel at a constant speed at the required acceleration.

According to such a configuration, when the abnormality information is received from the vehicle control interface box, the autonomous driving kit transmits required acceleration that matches a situation around the vehicle platform to the propulsion function unit. The required acceleration to be transmitted is required acceleration that increases or maintains a forward speed of the vehicle platform. The autonomous driving kit receives a response content indicating whether the propulsion function unit is generating a propulsive force that allows the vehicle platform to travel with acceleration or travel at a constant speed at the required acceleration. The autonomous driving kit can transmit an instruction to travel in the limp home mode that matches whether the response content is appropriate to the vehicle control interface box. As a result, it is possible to execute travel in the limp home mode further appropriately according to the remaining capacity of the propulsion function.

The vehicle may further include a predetermined function unit that executes a predetermined function different from the propulsion function unit;
the vehicle control interface box may further relay control communication between the autonomous driving kit and the predetermined function unit; and
the autonomous driving kit may be configured to
receive the abnormality information indicating an abnormality of a propulsion function of the propulsion function unit or an abnormality of the predetermined function of the predetermined function unit, and
when the abnormality information is received, transmit an instruction to travel in the limp home mode that matches a content of the abnormality indicated by the abnormality information to the vehicle control interface box on condition that the abnormality indicated by the abnormality information is an abnormality that requires the vehicle to stop.

According to such a configuration, the autonomous driving kit can transmit an instruction to travel in the limp home mode that matches a content of the abnormality indicated by the abnormality information to the vehicle control interface box on condition that the abnormality of the propulsion function of the vehicle platform or the predetermined function different from the propulsion function is an abnormality that requires the vehicle to stop. As a result, it is possible to execute travel in the limp home mode further appropriately according to the remaining capacity of the propulsion function or the predetermined function.

According to the present disclosure, it is possible to provide an autonomous driving kit capable of appropriately executing travel in the limp home mode according to the remaining capacity of the propulsion function.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of a vehicle according to an embodiment of the present disclosure;

FIG. 2 is a diagram illustrating a detailed configuration of ADK, VCIB and VP according to the embodiment;

FIG. 3 is a flowchart showing ADK, VCIB of the first embodiment and the flow of processes executed by the respective control systems; and

FIG. 4 is a flowchart showing ADK, VCIB of the second embodiment and the flow of processes executed by the respective control systems.

### DETAILED DESCRIPTION OF EMBODIMENTS

Hereinafter, embodiments of the present disclosure will be described in detail with reference to the drawings. The same or corresponding parts in the drawings are denoted by the same reference numerals, and the description thereof will not be repeated.

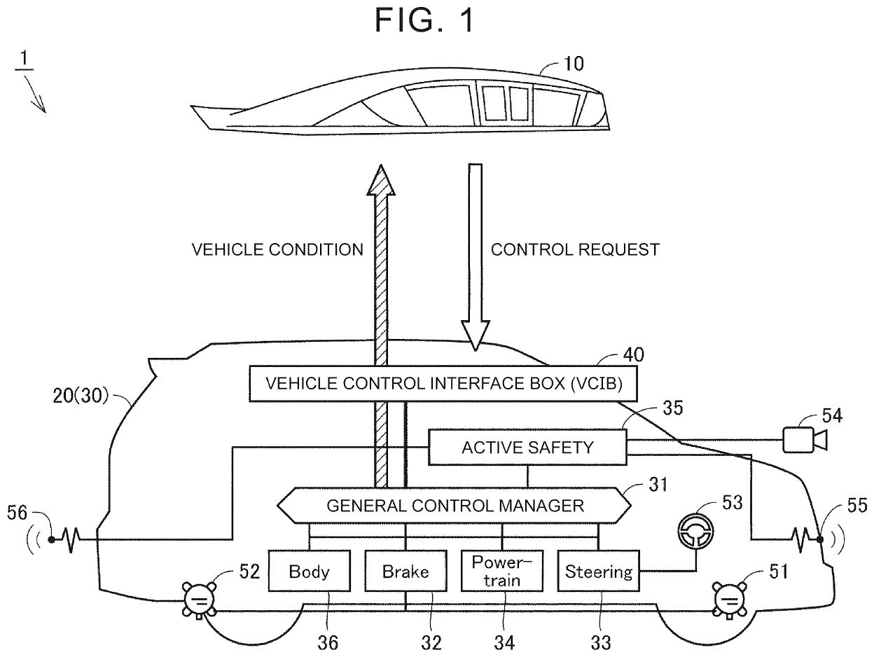

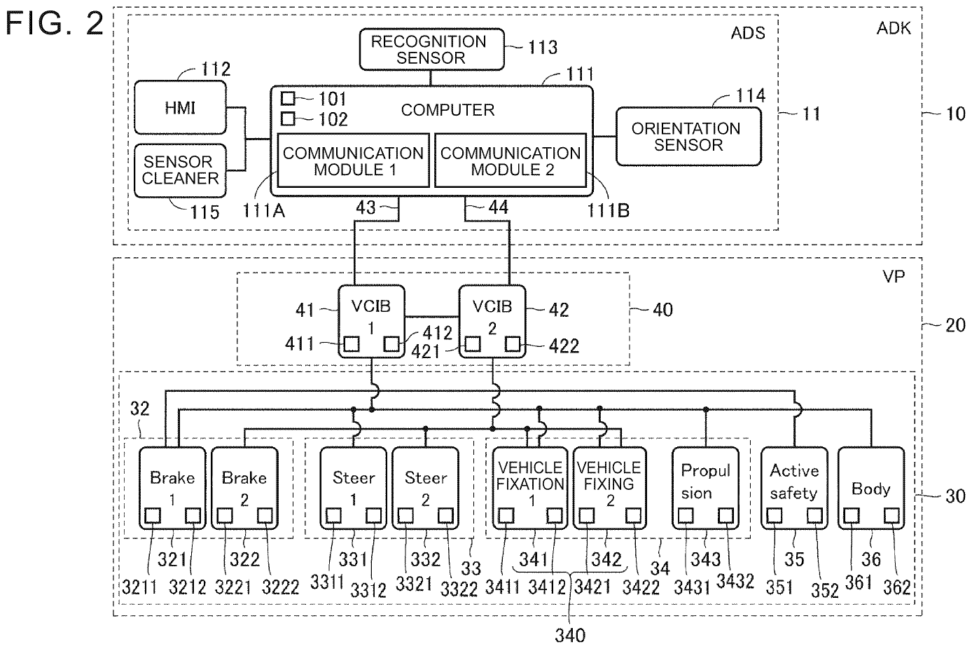

FIG. 1 is a diagram illustrating an outline of a vehicle 1 according to an embodiment of the present disclosure. FIG. 2 is a diagram illustrating a detailed configuration of ADK 10, VCIB 40 and VP 20 according to the embodiment. Referring to FIGS. 1 and 2, the vehicle 1 includes an ADK 10 and a VP 20. ADK 10 is configured to be attachable to VP 20 (mountable to the vehicles 1). ADK 10 and VP 20 are configured to be able to communicate with each other via a VCIB 40.

VP 20 can perform autonomous driving in accordance with control demands from ADK 10. In FIG. 1, although ADK 10 is shown at a position away from VP 20, ADK 10 is actually attached to a rooftop or the like of VP 20. ADK 10 can also be removed from VP 20. When ADK 10 is removed, VP 20 executes travel control (travel control according to user manipulation) in the manual mode (manual driving mode).

ADK 10 includes an autonomous driving system (ADS: Autonomous Driving System) 11 for performing autonomous driving of the vehicles 1. ADS 11 creates, for example, a travel plan of the vehicles 1. ADS 11 outputs various control requests for causing the vehicle 1 to travel in accordance with the travel plan to VP 20 in accordance with an API (Application Program Interface) defined for each control request. Further, ADS 11 receives various signals indicating the vehicle state (VP 20 state) from VP 20 according to an API defined for each signal. Then, ADS 11 reflects the condition of the vehicle in the travel plan.

VP 20 includes a base vehicle 30 and a VCIB 40. The base vehicle 30 executes various types of vehicle control in accordance with control demands from ADK 10 (ADS 11). The base vehicle 30 includes various in-vehicle systems and various sensors for controlling the base vehicle 30. More specifically, the base vehicle 30 includes an integrated control manager 31, a brake system 32, a steering system 33, a power train system 34, and an active safety system 35. The base vehicle 30 further includes a body system 36, wheel speed sensors 51 and 52, a pinion angle sensor 53, a camera 54, and radar sensors 55 and 56.

The integrated control manager 31 includes processors such as CPU (Central Processing Unit) and memories such as ROM (Read Only Memory) and RAM (Random Access Memory). The integrated control manager 31 integrates and controls the respective systems (the brake system 32, the steering system 33, the power train system 34, the active safety system 35, and the body system 36) related to the operation of the vehicle 1.

The brake system 32 is configured to control a braking device provided on each wheel of the base vehicle 30. The braking device includes, for example, a disc brake system that operates in response to hydraulic pressure regulated by an actuator.

The wheel speed sensors 51 and 52 are connected to the brake system 32. The wheel speed sensors 51 and 52 detect the rotational speeds of the front wheels and the rear wheels of the base vehicle 30, respectively, and output the detected rotational speeds of the front wheels and the rear wheels to the brake system 32. The brake system 32 outputs the rotational speed of the wheels to VCIB 40 as one of the information included in the vehicle state. In addition, the brake system 32 generates a braking command for the braking device in accordance with a predetermined control demand outputted from ADS 11 via VCIB 40 and the integrated control manager 31. The brake system 32 controls the braking device using the generated braking command. The integrated control manager 31 can calculate the speed (vehicle speed) of the vehicle 1 based on the rotational speed of each wheel.

The steering system 33 is configured to be able to control the steering angle of the steered wheels of the vehicle 1 (the turning angle of the tire) by using a steering device. The steering device includes, for example, a rack-and-pinion electric power steering (EPS: Electric Power Steering) capable of adjusting a steering angle by an actuator.

A pinion angle sensor 53 is connected to the steering system 33. The pinion angle sensor 53 detects a rotation angle (pinion angle) of the pinion gear connected to the rotation shaft of the actuator, and outputs the detected pinion angle to the steering system 33. The steering system 33 outputs the pinion angle to VCIB 40 as one of information included in the vehicle status. In addition, the steering system 33 generates a steering command for the steering device in accordance with a predetermined control request outputted from ADS 11 via VCIB 40 and the integrated control manager 31. The steering system 33 controls the steering device by using the generated steering command.

The power train system 34 controls the vehicle fixation system 341, 342 and the propulsion system 343. The vehicle fixing device 341, 342 controls an electric parking brake (EPB: Electric Parking Brake) provided on at least one of the plurality of wheels and a parking lock (P-Lock) device provided on a transmission of the vehicle 1. A shift device configured to select a shift range for controlling the propulsion system 343 is included.

The active safety system 35 uses the camera 54 and the radar sensors 55 and 56 to detect obstacles (pedestrians, bicycles, parked vehicles, utility poles, and the like) in the front or rear. The active safety system 35 determines whether the vehicle 1 is likely to collide with an obstacle based on the distance between the vehicle 1 and the obstacle and the moving direction of the vehicle 1. When the active safety system 35 determines that there is a possibility of a collision, it outputs a braking command to the brake system 32 via the integrated control manager 31 so that the braking force increases.

The body system 36 is configured to control components such as a direction indicator (a turn lamp, a hazard lamp), a horn, a wiper, a headlamp, and a brake lamp according to, for example, a traveling state or an environment of the vehicle 1. The body system 36 controls the above-described components according to predetermined control requirements outputted from ADS 11 via VCIB 40 and the integrated control manager 31.

VCIB 40 is configured to be able to communicate with ADS 11 through CAN (Controller Area Network) or the like. VCIB 40 executes a predetermined API defined for each signal, and thereby receives various control requests from ADS 11 and outputs the vehicle status to ADS 11. When receiving the control request from ADK 10, VCIB 40 outputs a control command corresponding to the control request to the control command via the integrated control manager 31. Further, VCIB 40 acquires various types of information of the base vehicle 30 from various systems via the integrated control manager 31, and outputs the state of the base vehicle 30 as a vehicle state to ADS 11.

Note that the vehicles 1 can be used as one of the configurations of MaaS (Mobility as a Service). MaaS system comprises, for example, a data server and a mobility service platform (MSPF: Mobility Service Platform) in addition to the vehicle 1.

A MSPF is a unified platform to which various mobility services are connected. A mobility service related to autonomous driving is connected to MSPF. A mobility service provided by a ride sharing company, a car sharing company, a rental car company, a taxi company, an insurance company, or the like may be connected to MSPF in addition to the mobility service related to autonomous driving.

The vehicles 1 further comprise a DCM (Data Communication Module) capable of wirelessly communicating with the data servers. DCM provides vehicle-information to the data servers, such as velocity, location, and autonomous driving status, for example. DCM also receives various data for managing the travel of the autonomous vehicle including the vehicle 1 in the autonomous driving related mobility service, for example, from the mobility service through MSPF and the data server.

In MSPF, an API for using various types of vehicle conditions and vehicle control required for developing an ADS 11 is disclosed. Various types of mobility services can use various functions provided by MSPF according to service content using API published on MSPF. For example, the autonomous driving-related mobility service can acquire driving control data of the vehicles 1, information stored in the data servers, and the like from MSPF using API published on MSPF. In addition, the mobility service related to the autonomous driving can transmit, for example, data for managing the autonomous vehicle including the vehicle 1 to MSPF using API.

ADS 11 includes a computer 111, a HMI (Human Machine Interface) 112, a recognition sensor 113, an attitude sensor 114, and a sensor cleaner 115.

The computer 111 includes a processor 101, such as a CPU, and memories 102, such as ROM and RAM. The memory 102 stores a program executable by the processor 101. The computer 111 acquires the environment of the vehicle 1 and the attitude, behavior, and position of the vehicle 1 by using various sensors (described later) during autonomous driving of the vehicle 1. At the same time, the computer 111 acquires the vehicle status from VP 20 through VCIB 40 and sets the subsequent operation (acceleration, deceleration, bending, and the like) of the vehicle 1. The computer 111 outputs various commands for realizing the following operations to VCIB 40. Computer 111 further includes a communication module 111A, 111B. Each of the communication module 111A, 111B is configured to be capable of communicating with a VCIB 40.

HMI 112 presents information to a user or accepts a user operation during autonomous driving, during manual driving requiring a user operation, during transition between autonomous driving and manual driving requiring a user operation, and the like. HMI 112 includes, for example, an input/output device such as a touch panel display provided in the base vehicle 30.

The recognition sensor 113 is a sensor for recognizing the environment of the vehicle 1. The recognition sensor 113 includes at least one of a LIDAR (Laser Imaging Detection and Ranging), a millimeter-wave radar, and a camera. The LIDAR emits, for example, infrared pulsed laser light and measures the distance and the direction of an object by detecting the reflected light of the laser light from the object. The millimeter wave radar measures the distance and the direction of an object by emitting millimeter waves and detecting the reflected waves of the millimeter waves from the object. The camera is arranged, for example, on the rear side of the room mirror and captures an image in front of the vehicle 1.

The attitude sensor 114 is a sensor for detecting the attitude, behavior, and position of the vehicle 1. The attitude sensor 114 includes, for example, IMU (Inertial Measurement Unit) and GPS (Global Positioning System). The IMU detects, for example, the longitudinal, lateral, and vertical accelerations of the vehicle 1 and the angular velocities of the vehicle 1 in the roll, pitch, and yaw directions. GPS detects the position of the vehicle 1 by using information received from a plurality of GPS satellites orbiting on the earth's orbit.

The sensor cleaner 115 is configured to remove dirt adhering to the various sensors (a lens of a camera, an irradiation unit of a laser beam, or the like) while the vehicle 1 is traveling by using a cleaning liquid, a wiper, or the like.

VCIB 40 includes a main VCIB 41 and a sub-part VCIB 42. VCIB 41, 42 includes a processor 411, 421, such as a CPU, and memories 412, 422, such as ROM and RAM, respectively. The memory 412, 422 stores programs executable by the processor 411, 421 and data processed by the programs, respectively. The main VCIB 41 and the communication module 111A are communicably connected to each other through a communication bus 43 (main bus). The sub VCIB 42 and the communication module 111B are connected to each other via a communication bus 44 (sub bus) so as to be able to communicate with each other. Further, the main VCIB 41 and the sub VCIB 42 are communicably connected to each other.

Each of VCIB 41, 42 relays control requirements and vehicle-information between ADS 11 and VP 20. VCIB 41, 42 interfaces between the base vehicle 30 and ADS 11 through communication busses 43, 44. VCIB 41, 42 uses API to generate a control command from a control demand from ADS 11.

The control command corresponding to the control request supplied from ADS 11 to VCIB 40 includes, for example, a propulsion direction command, a fixed command, an acceleration command, a tire-breaking angle command, an autonomous command, and a stopping command. The propulsion direction command requests switching of the shift range. The immobility commands require activation/deactivation of EPB and P-Lock devices. The acceleration command requires acceleration or deceleration of the vehicle 1. The tire exhaustion angle command requests that the autonomous command requesting the tire exhaustion angle of the steered wheels switch between an autonomous (Autonomous) mode (autonomous driving mode) and a manual mode (manual driving mode). The stop command requests cancellation of the stop holding or the stop holding of the vehicle

Then, VCIB 41, 42 outputs the generated control command to the corresponding system among the plurality of systems included in VP 20. VCIB 41, 42 uses API to generate information indicating the vehicle status from the vehicle information from the respective systems of VP 20. The information indicating the vehicle status may be the same information as the vehicle information, or may be information obtained by extracting, from the vehicle information, information used in a process to be executed by ADS 11. VCIB 41, 42 outputs the generated information indicating the vehicle-state to ADS 11.

The brake system 32 includes a brake system 321, 322. The steering system 33 includes a steering system 331, 332. The power train system 34 includes a vehicle fixation system 340 and a propulsion system 343. The vehicle fixation system 340 includes a vehicle fixation system 341, 342.

VCIB 41, 42 basically has the same function, but VP 20 has different connection destinations to the in-vehicle device between VCIB 41, 42. Specifically, the main VCIB 41, the brake system 321, the steering system 331, the vehicle fixing system 341, 342, the propulsion system 343, and the body system 36 are communicably connected to each other via a communication bus. The sub VCIB 42, the brake system 322, the steering system 332, and the vehicle-fixing system 341, 342 are communicably connected to each other via a communication bus.

As described above, VCIB 40 includes VCIB 41, 42 having the same function with respect to the operation (braking, steering, and the like) of some of the systems, so that the control system between ADS 11 and VP 20 is made redundant. Therefore, when a certain failure occurs in the system, the function of VP 20 can be maintained by appropriately switching the control system or shutting off the control system in which the failure occurs.

The brake system 321, 322 includes processors 3211 and 3221, such as CPU, and memories 3212 and 3222, such as ROM and RAM, respectively. Each of the brake systems 321, 322 is configured to be capable of controlling a braking device. The brake system 321, 322 generates braking commands for the braking devices in accordance with control requirements outputted from ADS 11 via VCIB 41, 42. The brake system 321, 322 may have equivalent functionality. Alternatively, one of the brake systems 321, 322 may be configured to independently control the braking force of each wheel, and the other may be configured to be controllable to generate the same braking force on each wheel. The brake system 321, 322 controls the braking device using, for example, a braking command generated by one of the brake systems. When an abnormality occurs in the brake system, the brake system 321, 322 may control the braking device using the braking command generated by the other brake system.

The steering system 331, 332 includes processors 3311 and 3321, such as CPU, and memories 3312 and 3322, such as ROM and RAM, respectively. Each of the steering systems 331, 332 is configured to be able to control the steering angle of the steered wheels of the vehicle 1 by using a steering device. Each of the steering systems 331, 332 generates a steering command for the steering system in accordance with a control demand outputted from ADS 11 via VCIB 41, 42. The steering system 331, 332 may have equivalent functionality. Alternatively, the steering system 331, 332 controls the steering device using a steering command generated by one of the steering systems, for example. When an abnormality occurs in the steering system, the steering system 331, 332 may control the steering device using the steering command generated by the other steering system.

Vehicle-fixation-system 341, 342 includes processors 3411 and 3421, such as CPU, and memories 3412 and 3422, such as ROM and RAM, respectively. Vehicle-fixing system 341, 342 controls EPB and P-Lock devices in accordance with control requirements outputted from ADS 11 through VCIB 41, 42. EPB is provided separately from the braking device (e.g., disc brake system) and fixes the wheels by operation of the actuator. EPB may, for example, actuate a drum brake for a parking brake provided on a part of the plurality of wheels using an actuator to fix the wheels. Alternatively, EPB may actuate the braking device to lock the wheels, for example, using an actuator capable of adjusting the hydraulic pressure supplied to the braking device separately from the brake system 321, 322. The vehicle fixing system 341, 342 has a brake hold function and is configured to be capable of switching between activation and deactivation of the brake hold.

Vehicle-locking device 341, 342 activates P-Lock device, for example, when the control request includes a control request that puts the shift range into the parking range (P range). Further, the vehicle-fixing device 341, 342 may deactivate P-Lock device when the control request includes a control request for a shift range other than the P range. P-Lock device is configured to fit a protrusion at a distal end of a parking lock pole that can be adjusted by an actuator with respect to a tooth portion of a gear (lock gear) provided in connection with a rotating element in a transmission of the vehicle 1. As a result, the rotation of the output shaft of the transmission is fixed, and the wheels are fixed.

The propulsion system 343 includes a processor 3431, such as a CPU, and memories 3432, such as ROM and RAM. The propulsion system 343 includes a directional control system and a propulsion system. The directional control device is connected to VCIB 40. The direction control system controls the direction of travel (forward or reverse) of VP 20 by switching the shift range of the shifting device according to a control requirement outputted from ADS 11 via VCIB 41. The shift range includes a forward travel range (D range) and a reverse travel range (R range) in addition to the P range and the neutral range (N range). The propulsion system is connected to VCIB 40. The propulsion system controls the propulsion (e.g., acceleration and deceleration) of VP 20 by controlling the drive force from the drive source (motor generator, engine, etc.).

The active safety system 35 includes a processor 351, such as a CPU, and memories 352, such as ROM and RAM. The active safety system 35 is communicatively coupled to the brake system 321. As described above, the active safety system 35 detects a forward obstacle using the camera 54 and/or the radar sensor 55, and outputs a braking command to the brake system 321 so that the braking force increases when it is determined that there is a possibility of a collision.

The body system 36 includes a processor 361, such as a CPU, and memories 362, such as ROM and RAM. The body system 36 controls components such as turn indicators, horns, wipers and the like in accordance with control requirements outputted from ADS 11 via VCIB 41.

In the vehicle 1, the autonomous driving is executed when the autonomous mode (autonomous driving mode) is selected by the user's manipulation of HMI 112, for example. As described above, ADS 11 first creates a travel plan during the autonomous driving. Examples of the travel plan include a plan for continuing straight travel, a plan for turning left/right at a predetermined intersection in the middle of a predetermined travel route, a plan for changing a travel lane, and the like. ADS 11 calculates a control physical quantity (acceleration, deceleration, tire-out angle, and the like) required for the vehicle 1 to operate in accordance with the created travel plan. ADS 11 divides the physical quantity for each API run cycle. ADS 11 uses API to provide control demands to VCIB 40 that represent the divided physical quantities. Further, ADS 11 acquires a vehicle state (an actual moving direction of the vehicle 1, a state of fixing of the vehicle, and the like) from VP 20, and re-creates a travel plan reflecting the acquired vehicle state. In this way, ADS 11 enables autonomous driving of the vehicles 1.

In the above-described VP 20, failure diagnostics are performed in the respective systems such as the brake system 321, 322 and the steering system 331, 332, and the failure data is transmitted to VCIB 41, 42. Then, information on the presence or absence of a failure indicated by the failure information is transmitted from VCIB 41, 42 to ADK 10.

Conventionally, in VP 20, there has been a signal for notifying VCIB 41, 42 to ADK 10 of a decrease in the function related to the propulsion function. However, since ADK 10 does not know the details of the remaining capacity, it is difficult to perform an appropriate travel in a limp home mode in accordance with the remaining capacity.

Therefore, ADK 10 receives, from VCIB 41, 42, the abnormality information indicating the abnormality of the propulsion function by the propulsion system 343. When the abnormality information is received, ADK 10 transmits an instruction for the travel in the limp home mode to VCIB 41, 42 on condition that the abnormality indicated by the abnormality information is an abnormality requiring a stop.

Accordingly, ADK 10 can transmit an instruction for the travel in the limp home mode to VCIB 41, 42 on condition that the abnormality of the propulsion function of VP 20 is an abnormality requiring a stop. As a result, the travel in the limp home mode can be appropriately executed in accordance with the remaining capacity of the propulsion function.

### First Embodiment

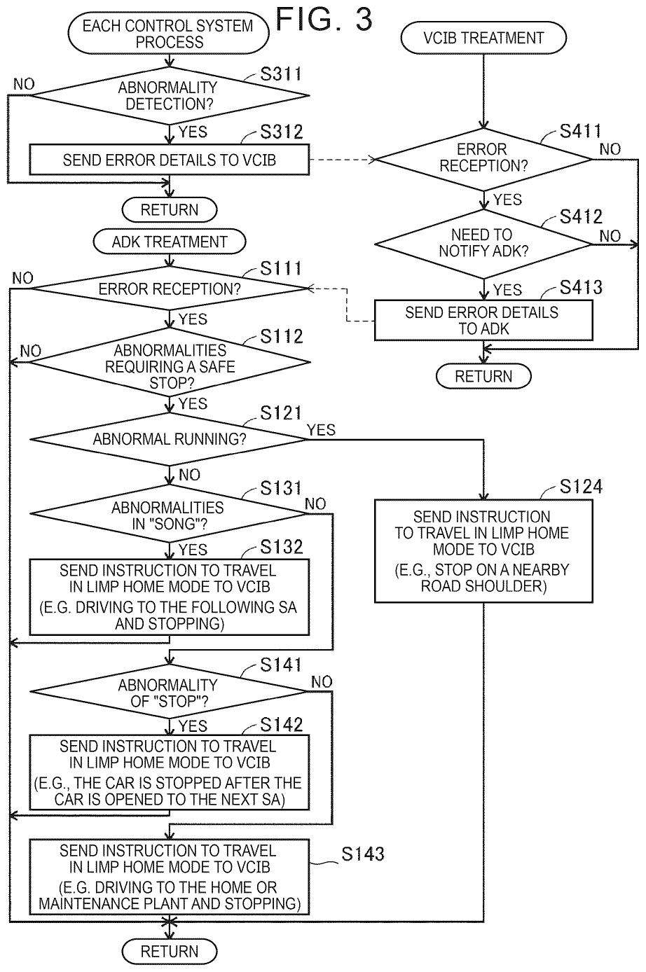

FIG. 3 is a flowchart showing ADK 10, VCIB 41, 42 of the first embodiment and the flow of processes executed by the respective control systems. Referring to FIG. 3, each control system process is invoked and executed by a processor of a control system of the base vehicle 30 from a higher-level process at predetermined intervals. The processor of the control system of the base vehicle 30 is, for example, the processor 3431 of the propulsion system 343 and the processors 3211, 3221 of the brake system 321, 322. Alternatively, the processor of the control system of the base vehicle 30 is, for example, the processors 3311 and 3321 of the steering system 331, 332 and the processors 3411 and 3421 of the vehicle fixing system 341, 342. VCIB process is called and executed by the processor 411, 421 of VCIB 41, 42 from the higher-order process at predetermined intervals. ADK process is called and executed by the processor 101 of ADS 11 computer 111 from the higher-level process at predetermined intervals.

In the base vehicle 30, the processor of the respective control systems monitors the abnormal condition of the base vehicle 30 and detects the abnormal condition (S311). When it is determined that an abnormality is detected (YES in S311), the processor of each control system classifies the detected abnormality into one of a propulsion system, a steering system braking system, and the like. Then, the processors of the respective control systems S312 the abnormality content such as the classification of the abnormality and the status of the abnormality to VCIB 41, 42.

The abnormality of the propulsion system includes, for example, an engine abnormality and a motor abnormality. The abnormality of the steering system includes, for example, a steering abnormality. The abnormality of the braking system includes, for example, a braking abnormality and an ABS abnormality. Other abnormalities include abnormalities that need to be taken to a maintenance facility or a place where maintenance is possible, such as at home, and other abnormalities. The abnormality that needs to go to a place where maintenance can be performed includes, for example, an abnormality that requires maintenance for each travel of a predetermined distance (specifically, a 5000 km or the like). Alternatively, the abnormality that needs to go to a place where maintenance is possible includes, for example, an abnormality that the camera 54 or the radar sensors 55 and 56 require maintenance due to dirt or the like, and an abnormality in a system used before moving the vehicle, such as a smart entry. Other abnormalities include, for example, airbag abnormalities.

When it is determined that no anomaly is detected (NO in S311), or after S312, the processor of each control system returns the processing to be executed to the processing of the upper level of the caller of each control system processing.

In VCIB 41, 42, the processor 411, 421 determines whether or not the abnormal content has been received from the respective control systems (S411). When it is determined that the abnormality content has been received (YES in S411), the processor 411, 421 determines whether or not the abnormality indicated by the received abnormality content is an abnormality requiring notification to ADK 10 (S412). The abnormality requiring notification includes, for example, an abnormality of the propulsion system, an abnormality of the steering system, an abnormality of the braking system, an abnormality requiring to go to a place where maintenance is possible, and an airbag abnormality.

The processor 411, 421 transmits the abnormality content to ADK 10 (S413) when it is determined that the abnormality requires notification to ADK 10 (YES in S412). When it is determined that the abnormality content has not been received (NO in S411) or when it is determined that the abnormality is not an abnormality requiring notification to ADK 10 (NO in S412), the processors 411 and 421 return the processing to be executed to the processing of the upper level of the caller of VCIB processing. Alternatively, after S413, the processors 411 and 421 return the processing to be executed to the processing higher than the caller of VCIB processing.

In ADK 10, the processor 101 of ADS 11 computer 111 uses the communication module 111A, 111B to determine whether or not an anomaly has been received from VCIB 41, 42 (S111). When it is determined that the abnormality content has been received (YES in S111), the processor 101 determines whether or not the abnormality indicated by the received abnormality content is an abnormality requiring a safe stop (S112). Abnormalities requiring a safe stop include, for example, abnormalities of a propulsion system, abnormalities of a steering system, abnormalities of a braking system, and some other abnormalities (for example, abnormalities related to safety such as an airbag abnormality).

When it is determined that the abnormality requires a safe stop (YES in S112), the processor 101 determines whether the abnormality indicated by the received abnormality content is an abnormality of “running”, that is, an abnormality of the propulsion system (S121). When it is determined that “running” is abnormal (YES in S121), the processor 101 controls the communication module 111A, 111B to transmit an instruction of the travel in the limp home mode to VCIB 41, 42 (S124). The travel in the limp home mode instruction here is, for example, an instruction to stop at a nearby road shoulder.

When it is determined that the abnormality is not an abnormality of “running” (NO in S121), the processor 101 determines whether the abnormality indicated by the received abnormality content is an abnormality of “song”, that is, an abnormality of the steering system (S131). When it is determined that the “song” is abnormal (YES in S131), the processor 101 controls the communication module 111A, 111B to transmit an instruction to VCIB 41, 42 to perform the travel in the limp home mode (S132). The instruction for the travel in the limp home mode here is, for example, an instruction to travel to a place where parking can be relatively close, such as the following service area (SA), and stop.

When it is determined that the abnormality of the “song” is not an abnormality (NO in S131), the processor 101 determines whether the abnormality indicated by the received abnormality content is an abnormality of the “stop”, that is, an abnormality of the braking system (S141). When it is determined that the “stop” is abnormal (YES in S141), the processor 101 controls the communication module 111A, 111B to transmit an instruction for the travel in the limp home mode to VCIB 41, 42 (S142). The instruction for the travel in the limp home mode here is, for example, an instruction to open a vehicle space to travel to a location where parking is relatively close, such as a subsequent service area (SA), and stop.

When it is determined that the “stop” is not abnormal (NO in S141), the processor 101 controls the communication module 111A, 111B to transmit an instruction for the travel in the limp home mode to VCIB 41, 42 (S143). The instruction for the travel in the limp home mode here is, for example, an instruction to travel to a home or a maintenance factory and stop.

When it is determined that the abnormality content has not been received (NO in S111), or when it is determined that the abnormality is not an abnormality requiring a safe stop (NO in S112), the processor 101 returns the processing to be executed to the processing of the upper level of the caller of ADK processing. Alternatively, after S124, after S132, after S142, or after S143, the processor 101 returns the processing to be executed to the processing of the upper level of the caller of ADK processing.

When VCIB 41, 42 receives an instruction of the travel in the limp home mode by a S124, S132, S142 or a S143, it transmits a control signal for the travel in the limp home mode to the control systems. Each control system executes an operation for the travel in the limp home mode in accordance with a control signal for the travel in the limp home mode.

By executing the processing of FIG. 3, abnormalities are classified into any of the propulsion system, the steering system, and the deceleration system. In addition, the abnormal content including the categorization is stratified into a running, a song, and a stop, and is notified to ADK 10. As a result, a safer travel in the limp home mode can be achieved.

### Second Embodiment

In the second embodiment, a process corresponding to the deformation of ADK process is added to S124 process and VCIB process in the event of an anomaly in the “running” of ADK process in FIG. 3 in the first embodiment. In the second embodiment, a portion changed from the first embodiment will be described.

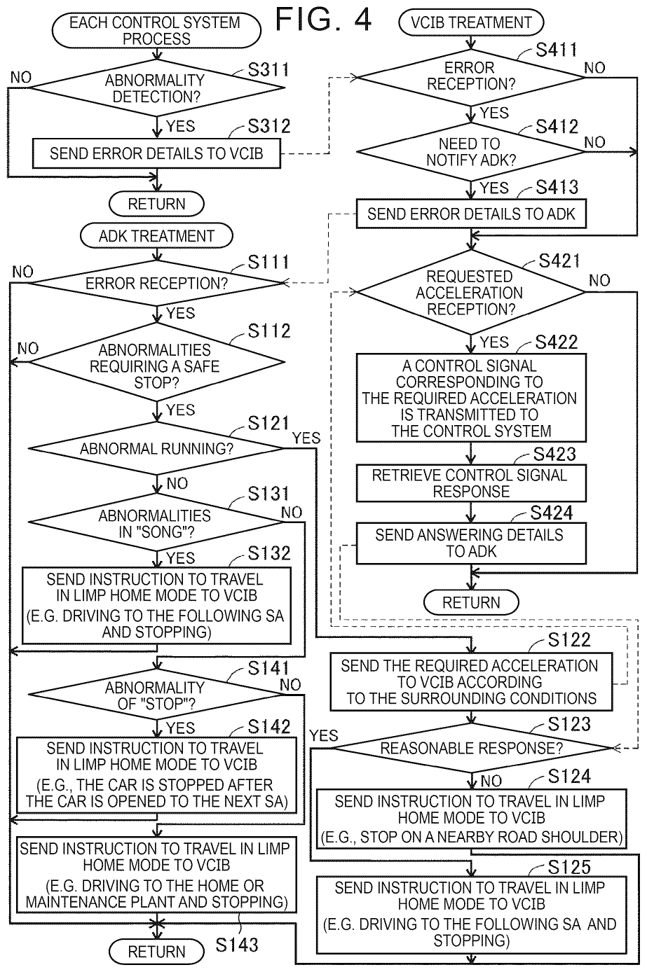

FIG. 4 is a flowchart showing ADK 10, VCIB 41, 42 of the second embodiment and the flow of processes executed by the respective control systems. Referring to FIG. 4, when it is determined in ADK 10 that the “running” is abnormal (YES in S121), the processor 101 of ADS 11 computer 111 acquires the status of the surroundings of the vehicles 1. Then, the processor 101 controls the communication module 111A, 111B to transmit the required acceleration corresponding to the surrounding condition to VCIB 41, 42 in order to confirm the propulsion response of the vehicle 1 (S122).

The surrounding situation includes, for example, a first situation in which the safety is maintained even if the vehicle 1 accelerates somewhat, a second situation in which the safety is maintained if the vehicle 1 is traveling at a constant speed, and a third situation in which consideration is necessary to maintain the safety of the vehicle 1. The first situation is a situation in which there are few other vehicles and people in the surroundings, for example, a situation in which the vehicle is traveling on an expressway and there are relatively few other vehicles in the surroundings. The second situation is a situation in which there are more other vehicles and people in the surroundings than in the first situation. The second situation is, for example, a situation in which the vehicle is traveling on an expressway, and there are more other vehicles in the surroundings than in the first situation, or a situation in which the vehicle is traveling on a general road, and there are no or fewer other vehicles and people in the surroundings. The third situation is a situation in which there are more other vehicles and people in the surroundings than in the second situation. The third situation is, for example, a situation in which the vehicle is traveling on an expressway and the other vehicle is in a traffic jam in the surroundings as compared with the second situation, or a situation in which the vehicle is traveling on a general road and the other vehicle and the person are in the surroundings as compared with the second situation.

When the situation around the vehicle 1 is the first situation, the requested acceleration to be transmitted is an acceleration at which the vehicle 1 for confirming the propulsion reaction of the vehicle 1 accelerates somewhat. When the situation around the vehicle 1 is the second situation, the requested acceleration to be transmitted is an acceleration at which the vehicle 1 travels at a constant speed to confirm the propulsion reaction of the vehicle 1. When the situation around the vehicle 1 is the third situation, the required acceleration is not changed in order to confirm the propulsion reaction of the vehicle 1.

When it is determined in VCIB 41, 42 that the abnormality content has not been received (NO in S411), or when it is determined that the abnormality needs to be notified to ADK 10 (NO in S412), the processors 411 and 421 determine whether or not the requested acceleration has been received from ADK 10 (S421). Alternatively, after S413, the processor 411 or 421 determines whether or not the requested acceleration has been received from ADK 10 (S421).

When it is determined that the requested acceleration has been received (YES in S421), the processor 411, 421 transmits a control signal corresponding to the requested acceleration to the respective control systems such as the propulsion system 343 and the brake system 321, 322 (S422).

The processor 411, 421 then S423 the control signals from the respective control systems (e.g., the actual velocity and the actual acceleration of the vehicle 1). The response is detected by, for example, the wheel speed sensors 51 and 52, the G sensor, the camera 54, the radar sensors 55 and 56, and the lidar. The processor 411, 421 transmits the obtained reply to ADK 10 (S424). The response content indicates whether or not a control system such as the propulsion system 343 and the brake system 321, 322 generates a propulsive force that causes the vehicle 1 to accelerate or travel at a constant speed at the required acceleration.

When it is determined that the requested acceleration has not been received (NO in S421), or after S424, the processor 411, 421 returns the processing to be executed to the processing of the upper level of the caller of VCIB processing.

In ADK 10, the processor 101 of ADS 11 computer 111 receives the content of the response to the requested acceleration at the communication module 111A, 111B and determines whether the response indicated by the response content is valid (S123). For example, when the actual acceleration (or change in actual speed) is within a predetermined error range with respect to the requested acceleration, the processor 101 determines that the response is valid.

When it is determined that the reply is not valid (NO in S123), the processor 101 executes S124 process described in the first embodiment. On the other hand, when it is determined that the reply is valid (YES in S123), the processor 101 controls the communication module 111A, 111B to transmit an instruction to VCIB 41, 42 to perform the travel in the limp home mode (S125). The instruction for the travel in the limp home mode here is, for example, an instruction to travel to a place where parking can be relatively close, such as the following service area (SA), and stop. After S125, the processor 101 returns the processing to be executed to the processing of the upper level of the caller of ADK processing.

By executing the processing of FIG. 4, abnormalities are classified into any of the propulsion system, the steering system, and the deceleration system. In addition, the abnormal content including the categorization is stratified into a running, a song, and a stop, and is notified to ADK 10. Accordingly, the remaining function can be actively checked in accordance with the abnormal condition by performing the driving, steering, and deceleration inputting tests on ADK 10 in accordance with the surrounding condition (environmental condition). As a result, a safer travel in the limp home mode can be achieved.

### Modified Examples

(1) In the above-described embodiment, as illustrated in FIGS. 3 and 4, ADK 10 acquires not only an abnormality in the propulsion function but also an abnormality in the steering function and the braking function. However, the present disclosure is not limited thereto, and ADK 10 may acquire only the abnormality of the propulsion function, may acquire the abnormality of the propulsion function and the steering function, or may acquire the abnormality of the propulsion function and the braking function.
(2) The above-described embodiments can be regarded as disclosure of a device such as a vehicle 1, a ADK 10, ADS 11, VP 20, a base vehicle 30, or a VCIB 41, 42, and can be regarded as disclosure of control methods or control programs in these devices.

### Summary

(1) As illustrated in FIGS. 1 and 2, ADK 10 is attachable to and detachable from a VP 20 configured to issue an instruction for autonomous driving and enable autonomous driving. As illustrated in FIGS. 1 and 2, VP 20 includes a base vehicle 30, a propulsion function unit that propels the base vehicle 30 according to a propulsion instruction from ADK 10, and a VCIB 41, 42 that relays control communication between ADK 10 and the propulsion function unit. The propulsion function unit is, for example, a propulsion system 343 and a brake system 321, 322. As illustrated in FIGS. 3 and 4, ADK 10 receives (e.g., S111) from VCIB 41, 42 anomaly information indicating an anomaly in the propulsion function by the propulsion function unit. When the abnormality information is received, ADK 10 transmits an instruction for the travel in the limp home mode to VCIB 41, 42 on condition that the abnormality indicated by the abnormality information is an abnormality requiring a stop (for example, from S112 to S143).

Accordingly, ADK 10 can transmit an instruction for the travel in the limp home mode to VCIB 41, 42 on condition that the abnormality of the propulsion function of the base vehicle 30 is an abnormality requiring a stop. As a result, the travel in the limp home mode can be appropriately executed in accordance with the remaining capacity of the propulsion function.
(2) As illustrated in FIG. 4, when ADK 10 receives the abnormality information, it may transmit the required acceleration corresponding to the situation around the vehicle 1 to the propulsion function unit through VCIB 41, 42 (for example, S122). ADK 10 may receive a response content of the propulsion function unit according to the required acceleration through VCIB 41, 42 (e.g., S123). Further, ADK 10 may transmit (for example, S124, S125) to VCIB 41, 42 an instruction of the travel in the limp home mode according to whether or not the response content is appropriate, on condition that the response content is received.
Accordingly, when ADK 10 receives the abnormality information from VCIB 41, 42, it transmits the required acceleration corresponding to the situation around the vehicle 1 to the propulsion function unit. ADK 10 can receive the response content of the propulsion function unit corresponding to the requested acceleration, and transmit an instruction for the travel in the limp home mode corresponding to whether or not the response content is appropriate to VCIB 41, 42. As a result, the travel in the limp home mode can be executed more appropriately according to the remaining capacity of the propulsion function.
(3) As shown in S122, S423 and S424 of FIG. 4, the required acceleration is an acceleration that increases or maintains the forward velocity of the vehicle 1. The response content may be a content indicating whether or not the propulsion function unit generates a propulsive force for the vehicle 1 to accelerate or travel at a constant speed at the required acceleration.
Accordingly, when ADK 10 receives the abnormality information from VCIB 41, 42, it transmits the required acceleration for increasing or maintaining the forward speed of the vehicle 1 to the propulsion function unit in accordance with the situation around the vehicle 1. ADK 10 can receive a response content indicating whether or not the propulsion function unit generates a propulsive force for the vehicle 1 to accelerate or travel at a constant speed at the required acceleration, and can transmit an instruction for the travel in the limp home mode according to whether or not the response content is appropriate to VCIB 41, 42. As a result, the travel in the limp home mode can be executed more appropriately according to the remaining capacity of the propulsion function.
(4) As illustrated in FIGS. 1 and 2, VP 20 further includes a predetermined function unit (for example, the brake system 321, 322 and the steering system 331, 332) that performs a predetermined function (for example, a braking function and a steering function) that differs from the propulsion function unit. As illustrated in FIGS. 1 and 2, VCIB 41, 42 further relays control communication between ADK 10 and the predetermined functional unit. As illustrated in FIGS. 3 and 4, ADK 10 may receive abnormality information indicating an abnormality of the propulsion function by the propulsion function unit or an abnormality of the predetermined function by the predetermined function unit (for example, S111). When the abnormality information is received, ADK 10 may transmit, to VCIB 41, 42, an instruction of the travel in the limp home mode according to the content of the abnormality indicated by the abnormality information (for example, S143 from S112), on condition that the abnormality indicated by the abnormality information is an abnormality requiring a stop.

As a result, ADK 10 can transmit, to VCIB 41, 42, an instruction to perform the travel in the limp home mode according to the content of the abnormality indicated by the abnormality information, on condition that the abnormality of the predetermined function, which is different from VP 20 propulsion function or the propulsion function, is an abnormality requiring a stop. As a result, it is possible to further appropriately execute the travel in the limp home mode in accordance with the remaining capability of the propulsion function or the predetermined function.

The embodiment disclosed herein should be considered to be exemplary and not restrictive in all respects. The scope of the present disclosure is shown by the scope of claims rather than the description of the above embodiments, and is intended to include all modifications within the meaning and the scope equivalent to the scope of claims.

What is claimed is:

1. An autonomous driving kit that issues an instruction for autonomous driving,
the autonomous driving kit being attachable to and detachable from a vehicle configured to be autonomously drivable,
the vehicle including
a vehicle platform,
a propulsion function unit that propels the vehicle platform according to a propulsion instruction from the autonomous driving kit, and
a vehicle control interface box that relays control communication between the autonomous driving kit and the propulsion function unit, wherein
the autonomous driving kit is configured to
receive abnormality information indicating an abnormality of a propulsion function of the propulsion function unit from the vehicle control interface box, and
when the abnormality information is received, transmit an instruction to travel in a limp home mode to the vehicle control interface box on condition that the abnormality indicated by the abnormality information is an abnormality that requires the vehicle to stop.

2. The autonomous driving kit according to claim 1, wherein the autonomous driving kit is configured to
when the abnormality information is received, transmit required acceleration that matches a situation around the vehicle platform to the propulsion function unit by way of the vehicle control interface box,
receive a response content of a response of the propulsion function unit that matches the required acceleration by way of the vehicle control interface box, and
on further condition that the response content is received, transmit an instruction to travel in the limp home mode that matches whether the response content is appropriate to the vehicle control interface box.

3. The autonomous driving kit according to claim 2, wherein:
the required acceleration is acceleration that increases or maintains a forward speed of the vehicle platform; and
the response content is a content indicating whether the propulsion function unit is generating a propulsive force that allows the vehicle platform to travel with acceleration or travel at a constant speed at the required acceleration.

4. The autonomous driving kit according to claim 1, wherein:
the vehicle further includes a predetermined function unit that executes a predetermined function different from the propulsion function unit;
the vehicle control interface box further relays control communication between the autonomous driving kit and the predetermined function unit; and
the autonomous driving kit is configured to
receive the abnormality information indicating an abnormality of a propulsion function of the propulsion function unit or an abnormality of the predetermined function of the predetermined function unit, and
when the abnormality information is received, transmit an instruction to travel in the limp home mode that matches a content of the abnormality indicated by the abnormality information to the vehicle control interface box on condition that the abnormality indicated by the abnormality information is an abnormality that requires the vehicle to stop.
